(19) United States
(12) Patent Application Publication
(10) Pub. No.: US 2026/0217040 A1
(43) Pub. Date: Jul. 30, 2026

(54) SHEET SUPPLY APPARATUS, CONTROL APPARATUS, AND PRINTING APPARATUS

(71) Applicant: CANON KABUSHIKI KAISHA, Tokyo (JP)

(72) Inventor: RYOTA IMAI, Kanagawa (JP)

(21) Appl. No.: 19/457,427

(22) Filed: Jan. 23, 2026

(30) Foreign Application Priority Data
Jan. 24, 2025 (JP) 2025-010515

(51) Int. Cl. B41J 15/04; B41J 11/00

(52) U.S. Cl. CPC B41J 15/04; B41J 11/0075; B41J 11/0095

(57) ABSTRACT

Conveyance malfunctions of a sheet are to be prevented in advance. A sheet supply apparatus includes: a roll holding unit configured to rotatably hold a roll on which a sheet that serves as a print medium is wound; one or more memories storing instructions; and one or more processors which function as: a notification unit configured to provide a notification related to supply of the roll, based on a degree of curvature of an outer periphery of the roll held by the roll holding unit.

### FIELD OF THE TECHNOLOGY

The present disclosure relates to a sheet supply apparatus, a control apparatus, and a printing apparatus.

### DESCRIPTION OF THE RELATED ART

The specification of US Patent Application Publication No. 2022/0297968 discloses a printing apparatus capable of detecting the leading end of a sheet on a mounted roll to automatically convey the sheet. This type of printing apparatus detects the leading end of a sheet using a sensor while rotating a roll in a winding direction that is opposite to the supply direction. Once detection is completed, the printing apparatus rotates the roll in the supply direction to automatically separate the leading end of the sheet from the roll.

### SUMMARY

There is a case in which a paper jam or other conveyance malfunction occurs due to abnormal advancement of the leading end of a sheet. Therefore, it is required to prevent conveyance malfunctions of a sheet in advance.

A sheet supply apparatus according to an aspect of the present disclosure includes: a roll holding unit configured to rotatably hold a roll on which a sheet that serves as a print medium is wound; one or more memories storing instructions; and one or more processors which function as: a notification unit configured to provide a notification related to supply of the roll, based on a degree of curvature of an outer periphery of the roll held by the roll holding unit.

Features of the present disclosure will become apparent from the following description of embodiments with reference to the attached drawings. The following description of embodiments are described by way of example.

### BRIEF DESCRIPTION OF THE DRAWINGS

FIG. 1 is a perspective view illustrating an example of the configuration of a printing apparatus;

FIG. 2 is a schematic cross-sectional view illustrating an example of the configuration of the main part of the printing apparatus;

FIG. 3 is a diagram illustrating an example of the configuration of a sheet supply unit;

FIG. 4 is a block diagram illustrating an example of the configuration of a control system in the printing apparatus;

FIG. 5 is a flowchart illustrating an example of automatic sheet supply processing in the first embodiment;

FIG. 6 is a diagram for describing calculation of the radius of an outer diameter of a roll;

FIG. 7 is a diagram illustrating a threshold value table;

FIG. 8 is a flowchart illustrating an example of automatic sheet supply processing in the second embodiment; and

FIG. 9 is a diagram illustrating an example of a notification screen.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically. Incidentally, an identical reference numeral is assigned to an identical constituent and an explanation thereof is made.

### First Embodiment

Hereinafter, with reference to the drawings, a description is given about a printing apparatus, which is an example to which the present disclosure is applied. In the referenced drawings, the X direction, Y direction, and Z direction are defined. The X direction and Y direction are perpendicular to each other. The Z direction is perpendicular to the X-Y plane. In an example to which the present disclosure is applied, the Z direction is assumed to be the vertical direction. The printing apparatus, which is an example to which the present disclosure is applied, is an inkjet printing apparatus including a sheet supply unit, which serves as a sheet supply apparatus, and a printing unit. The sheet supply unit supplies a sheet, which is a print medium. The printing unit prints an image on a sheet supplied by the sheet supply unit.

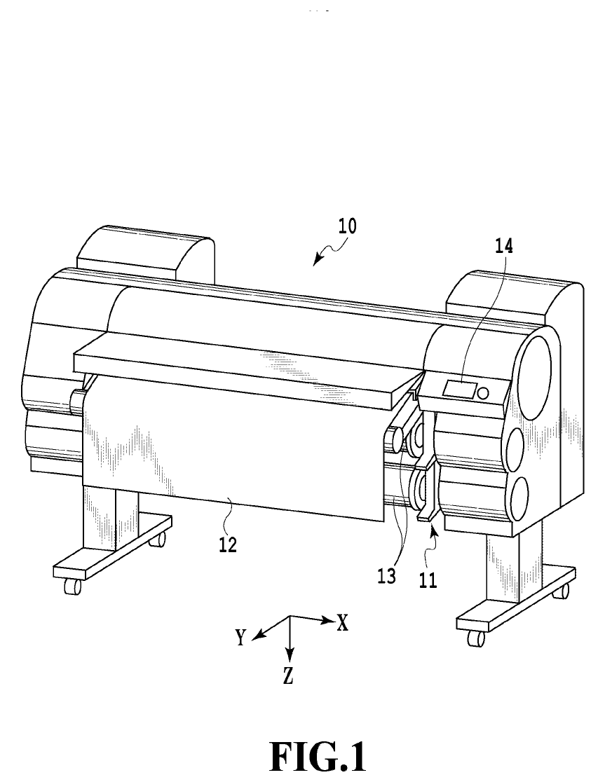

FIG. 1 is a perspective view illustrating an example of the configuration of a printing apparatus 10. The printing apparatus 10 includes the roll holding units 11. Each roll holding unit 11 holds the roll 13 on which the sheet 12, which is a print medium, is wound. In the example of FIG. 1, the roll holding unit 11 is arranged at two locations, namely, the upper portion and the lower portion. In this printing apparatus 10, the user is allowed to operate the operation panel 14 to input information related to the printing apparatus 10, such as designation of the type of a print medium. The operation panel 14 may be a touch panel.

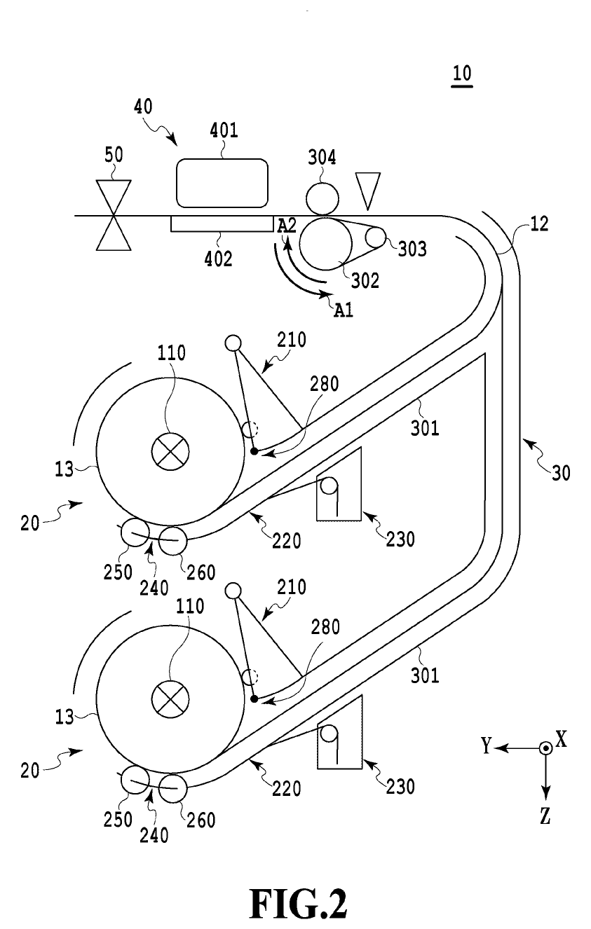

FIG. 2 is a schematic cross-sectional view illustrating an example of the configuration of the main part of the printing apparatus 10. In the printing apparatus 10, the two sheet supply units 20 corresponding to the two rolls 13 are arranged one above the other. Each sheet supply unit 20 can automatically separate and pull out the leading end of the sheet from the roll 13. The sheet 12, including the leading end separated and pulled out from the roll 13, is conveyed by the sheet conveyance unit 30 to the printing unit 40. The printing unit 40 prints an image on the conveyed sheet 12. The sheet 12 with a printed image is cut by the cutter 50. The sheet cut by the cutter 50 includes the image printed by the printing unit 40.

In each sheet supply unit 20, the roll 13 is set in the roll holding unit 11 in a rotatable manner (FIG. 1). In the example of FIG. 2, the members used for setting the rolls 13 in the roll holding units 11 in a rotatable manner are the spool members 110. Each spool member 110 is able to be set in the roll holding unit 11 in a state of being inserted into the hollow hole portion of the roll 13. If the spool member 110 set in the roll holding unit 11 rotates, the roll 13 rotates in conjunction with the rotation. The members used for setting the rolls 13 in the roll holding units 11 in a rotatable manner are not limited to the spool members 110. For example, the members used for setting the rolls 13 in the roll holding units 11 in a rotatable manner may be attachments, each of which is able to be mounted to the inside of the hollow hole portion from both sides of the roll 13.

The sheet conveyance unit 30 includes the conveyance guide 301, the conveyance roller 302, the conveyance motor 303, and the nip roller 304. The conveyance guide 301 guides the front and back surfaces of the sheet 12 pulled out from each sheet supply unit 20 while delivering the sheet 12 to the printing unit 40. The conveyance roller 302 is rotated by the conveyance motor 303 in the normal rotation direction A1 or the reverse rotation direction A2. The nip roller 304 rotates as a follower in accordance with the rotation of the conveyance roller 302. With a motor used for adjusting the nipping force, the nip roller 304 is able to be brought into contact with or separated from the conveyance roller 302, and is able to adjust the nipping force against the conveyance roller 302. The conveyance speed of the sheet 12 conveyed by the conveyance roller 302 is set to be higher than the speed at which the sheet 12 is pulled out by the rotation of the roll 13. In this case, back tension is applied to the sheet 12, and the sheet 12 is allowed to be conveyed with the back tension being applied.

The printing unit 40 includes the print head 401 and the platen 402. The print head 401 is a member that ejects ink from ejection ports, using ejection energy generating elements such as electrothermal conversion elements, piezoelectric elements, or the like. The platen 402 is a member that regulates the position of the sheet 12.

The print head 401 may eject each of four color inks: cyan (C), magenta (M), yellow (Y), and black (K). The inks to be ejected may include a white ink used for forming a background, a light color ink, a clear ink, a metallic ink, and a reaction liquid for fixing ink or the like to a print medium. The print head 401 is not limited to an inkjet system that ejects ink. For example, the print head 401 may employ a laser system. Further, the printing system of the printing unit 40 is not particularly limited. For example, the printing system may be a serial-scan system or a full-line system. In a serial-scan system, an image is printed in association with a conveyance operation of the sheet 12 and scans performed by the print head 401 in the direction intersecting the conveyance direction of the sheet 12. In a full-line system, the print head 401 extending in the direction intersecting the conveyance direction of the sheet 12 is used to print an image while the sheet 12 is continuously conveyed.

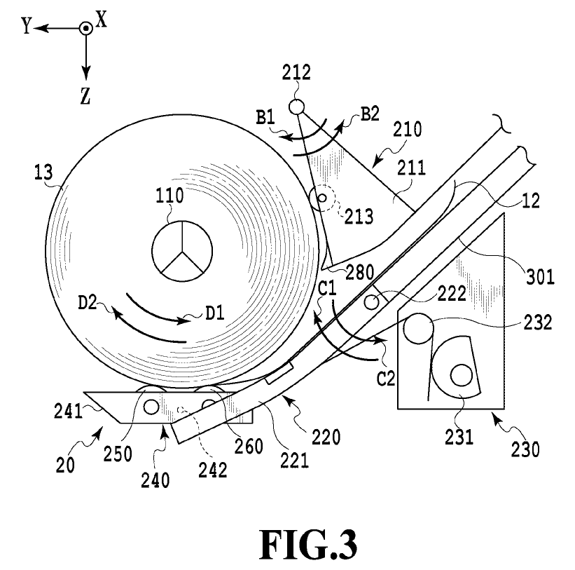

FIG. 3 is a diagram illustrating an example of the configuration of each sheet supply unit 20. Each sheet supply unit 20 includes the separation flapper 210, the arm member 220, the driving unit 230, the pivot member 240, the first follower rotating body 250, and the second follower rotating body 260.

The separation flapper 210 is attached to the printing apparatus body at a position above the arm member 220. The separation flapper 210 abuts against the outer peripheral surface of the roll 13 by its own weight so as to lightly press the roll 13. To increase the pressing force, a biasing member such as a spring may be used to bias the separation flapper 210. The separation flapper 210 includes the flapper body 211, the flapper rotation shaft 212, and the follower roller 213. The flapper body 211 is rotatable about the flapper rotation shaft 212 in the first rotation direction B1 or the second rotation direction B2. The flapper rotation shaft 212 is fixed to the printing apparatus body. The follower roller 213 is attached to the flapper body 211 in a rotatable manner so as to follow the rotation of the roll 13. The follower roller 213 abuts against the roll 13 to suppress an influence on the sheet 12 caused by the pressing force of the flapper body 211 applied to the roll 13.

The arm member 220 is attached to the conveyance guide 301. The space between the arm member 220 and the separation flapper 210 positioned above the arm member 220 serves as a sheet supply port. The sheet 12 pulled out from the roll 13 passes through the sheet supply port. The arm member 220 includes the arm body 221 and the arm rotation shaft 222. The arm body 221 is rotatable about the arm rotation shaft 222 in the first rotation direction C1 or the second rotation direction C2. The arm body 221 guides the lower surface of the sheet 12 pulled out from the roll 13. The arm rotation shaft 222 is fixed to the conveyance guide 301.

The driving unit 230 includes the rotating cam 231 and the biasing member 232. The biasing member 232 may be a torsion coil spring. The biasing member 232 is placed between the rotating cam 231 and the arm member 220. The biasing member 232 presses the arm member 220 in the first rotation direction C1. The force with which the biasing member 232 presses the arm member 220 in the first rotation direction C1 changes in accordance with the rotational position of the rotating cam 231. The rotating cam 231 is rotated by a pressure adjusting motor. The pressing force applied by the biasing member 232 to the arm member 220 may be switched in accordance with the rotational position of the rotating cam 231. For example, the pressing force applied by the biasing member 232 to the arm member 220 is switched among a first pressing force, a second pressing force greater than the first pressing force, and a third pressing force greater than the second pressing force. This switching is performed, for example, in a case where a sensor (not illustrated in the drawings) detects that the leading end of the sheet is positioned within the sheet supply port between the arm member 220 and the separation flapper 210.

The outer diameter of the roll 13 decreases in accordance with the amount of sheet 12 pulled out from the roll 13. Since the arm member 220 is constantly pressed by the biasing member 232 in the first rotation direction C1, even if the outer diameter of the roll 13 decreases, a supply path is formed between the arm member 220 and the separation flapper 210 so that the lower surface of the sheet 12 is guided. Further, the rotation amount of the rotating cam 231 is adjusted in accordance with a change in outer diameter of the roll 13, thereby maintaining the pressing force applied by the biasing member 232 to the arm member 220 within a predetermined range regardless of changes in outer diameter of the roll 13. Furthermore, since the separation flapper 210 is constantly pressed in the first rotation direction B1, even if the outer diameter of the roll 13 decreases, a supply path is formed between the separation flapper 210 and the arm member 220 so that the upper surface of the sheet 12 is guided. In this way, the separation flapper 210 and the arm member 220 rotate in accordance with a change in outer diameter of the roll 13, and thus, even if the outer diameter of the roll 13 decreases, a supply path having an approximately constant size is formed between the separation flapper 210 and the arm member 220.

The pivot member 240 is pivotably attached to the arm member 220. The pivot member 240 includes the pivot body 241 and the pivot shaft 242. The pivot body 241 is supported by the pivot shaft 242 so as to maintain a stable posture in each of the X-axis direction, the Y-axis direction, and the Z-axis direction. The pivot shaft 242 is fixed to the arm member 220.

The first follower rotating body 250 and the second follower rotating body 260 are attached to the pivot body 241 in a rotatable manner. The first follower rotating body 250 and the second follower rotating body 260 are positioned so as to be offset from each other in the circumferential direction of the roll 13. The first follower rotating body 250 and the second follower rotating body 260 are brought into pressure contact with the outer peripheral portion of the roll 13 from below in the direction of gravity by the pressing force in the first rotation direction C1. That is, the first follower rotating body 250 and the second follower rotating body 260 make pressure contact with the outer peripheral portion of the roll 13 from below the horizontal central axis of the roll 13 in the direction of gravity. This pressure contact force changes in accordance with the pressing force that presses the arm member 220 in the first rotation direction C1.

In each sheet supply unit 20, the sheet 12 passes above the first follower rotating body 250 and the second follower rotating body 260, and then is separated and pulled out from the roll 13. The sheet 12 separated and pulled out from the roll 13 is first guided, at its lower surface, by the arm member 220. Then, the sheet 12 is supplied between the arm member 220 and the separation flapper 210. The first follower rotating body 250, the second follower rotating body 260, the separation flapper 210, and the arm member 220 are substantially movable in the radial direction of the roll 13. Therefore, even if the outer diameter of the roll 13 decreases in accordance with the amount of sheet 12 pulled out from the roll 13, the sheet 12 can be smoothly supplied.

The type of roll 13 held by each roll holding unit 11 (FIG. 1) is not limited to one type. Therefore, even if the sheet 12 is not being pulled out from the roll 13, the outer diameter of the roll 13 held by the roll holding unit 11 may change. The smaller the outer diameter of the roll 13 held by the roll holding unit 11, the greater the degree of curvature of the outer periphery of the roll 13, making jams more likely to occur. This is because the leading end of the sheet pulled out from the roll 13 that may possibly curl and get caught on the supply path, thereby hindering the advance of the sheet 12. In the present embodiment, measures are taken to prevent the occurrence of jams in advance. As one of the measures, the printing apparatus 10 provides a notification related to the supply of the roll 13, based on the degree of curvature of the outer periphery of the roll 13 held by the roll holding unit 11. Details are described later.

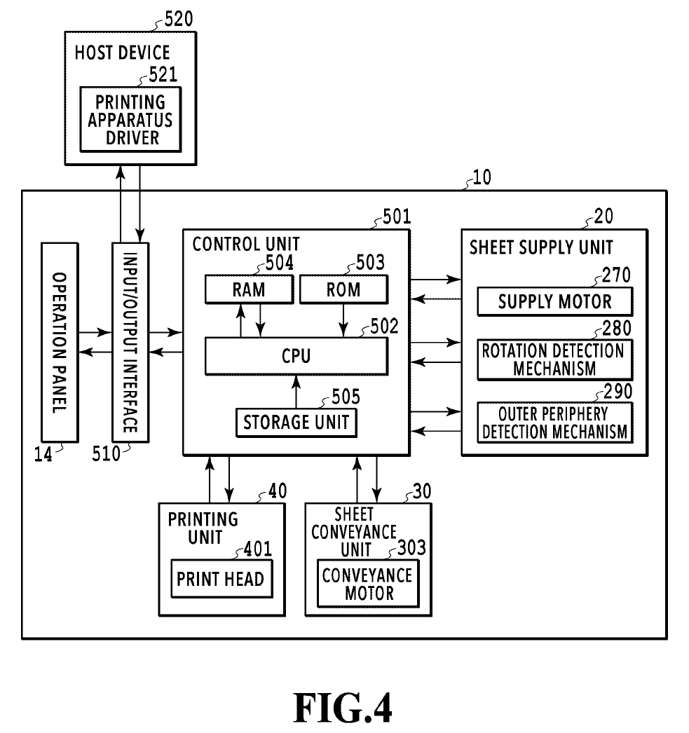

FIG. 4 is a block diagram illustrating an example of the configuration of a control system in the printing apparatus 10. The printing apparatus 10 includes the control unit 501 as a control apparatus. The control unit 501 includes the CPU 502, the ROM 503, the RAM 504, and the storage unit 505.

The CPU 502 is a processing unit for implementing various functions of the printing apparatus 10. The CPU 502 is one of the processors. The CPU 502 performs various processes by executing programs or activating hardware. Each program is executed by loading the program into the RAM 504. The processes performed by the CPU 502 includes control of the sheet supply units 20, the sheet conveyance unit 30, and the printing unit 40.

The ROM 503 stores various kinds of data. For example, the ROM 503 stores a program for the CPU 502 to execute processing. This program includes a device driver or the like. Further, the ROM 503 stores data necessary for the operation of the printing apparatus 10.

The RAM 504 is used as a work area for the CPU 502. That is, data necessary for the CPU 502 to execute processing is stored. This data also includes programs. The RAM 504 can also be used as a temporary storage area for data.

The storage unit 505 is a storage device such as a hard disk drive device. In the storage unit 505, various kinds of driver software, various kinds of application software, and the like are recorded (stored).

The control unit 501 is connected to the input/output interface 510. The input/output interface 510 can transmit various kinds of information between the control unit 501 and the operation panel 14. For example, the input/output interface 510 transmits medium type information indicating the type of a print medium, various kinds of setting information, and the like from the operation panel 14 to the control unit 501. Further, the input/output interface 510 can transmit various kinds of information between the control unit 501 and the host device 520. For example, the input/output interface 510 transmits print data for printing an image on the sheet 12 using the printing unit 40 from the host device 520 to the control unit 501.

The host device 520 is an information processing device capable of processing various kinds of information. The host device 520 is located outside the printing apparatus 10. The host device 520 includes the printing apparatus driver 521. The printing apparatus driver 521 can exchange various kinds of information with the printing apparatus 10. The printing apparatus driver 521 can cause the printing apparatus 10 to print an image on a print medium. For example, the printing apparatus driver 521 generates print data for printing an image on the sheet 12 using the printing unit 40, and supplies the print data to the printing apparatus 10 via the input/output interface 510.

The control unit 501 is connected to each part of the sheet supply units 20. The parts of each sheet supply unit 20 include the supply motor 270, the rotation detection mechanism 280, and the outer periphery detection mechanism 290.

As illustrated in FIG. 3, the supply motor 270 is a motor that rotates the roll 13 in the normal rotation direction D1 or the reverse rotation direction D2. If the roll 13 rotates in the normal rotation direction D1, the sheet 12 is pulled out from the roll 13 and advances in the conveyance direction. That is, the normal rotation direction D1 corresponds to the supply direction of the sheet 12 or the pull-out direction in which the sheet 12 is pulled out from the roll 13. On the other hand, the reverse rotation direction D2 corresponds to the winding direction in which the sheet 12 is wound. The supply motor 270 drives a member used for setting the roll 13 in the roll holding unit 11 in a rotatable manner (FIG. 1) under the control of the control unit 501, and rotates the roll 13 in the normal rotation direction D1 or the reverse rotation direction D2. In the example of FIG. 2 and FIG. 3, the members used for setting the rolls 13 in the roll holding units 11 in a rotatable manner are the spool members 110.

Each rotation detection mechanism 280 is a detection mechanism that detects the rotation amount of the roll 13. In the example of FIG. 2 and FIG. 3, the rotation detection mechanisms 280 are attached to the flapper bodies 211. In a case where the rotation detection mechanisms 280 are attached to the flapper bodies 211, each rotation detection mechanism 280 judges one rotation of the roll 13 by detecting the leading end of the sheet peeled (separated) from the roll 13. That is, each rotation detection mechanism 280 detects, as one rotation of the roll 13, the rotation amount from the point in time at which the leading end portion of the sheet that has slightly peeled off from the roll 13 is detected until the point in time at which the leading end portion of the sheet is detected again. In a case it is preferable to rotate the roll 13 in the reverse rotation direction D2. This is because the sheet 12 will not be pulled out from the roll 13, and thus the rotation detection mechanism 280 is able to detect the leading end of the sheet properly.

Each rotation detection mechanism 280 is not limited to a mechanism that detects the leading end of the sheet to detect the rotation amount of the roll 13. For example, each rotation detection mechanism 280 may detect the rotation amount, based on a signal obtained from a rotary encoder attached to the supply motor 270. Alternatively, in a case where the supply motor 270 is a stepping motor or the like, the rotation detection mechanism 280 may detect the rotation amount by sending a designated pulse signal to the supply motor 270. The rotation amount detected by each rotation detection mechanism 280 is supplied to the control unit 501.

Each outer periphery detection mechanism 290 is a detection mechanism that detects the outer peripheral length, which is the length of the outer periphery of the roll 13. The outer periphery detection mechanism 290 includes a rotary encoder attached to at least one of the first follower rotating body 250 and the second follower rotating body 260. Each outer periphery detection mechanism 290 detects the outer peripheral length of the roll 13, based on a signal output from this rotary encoder.

Each outer periphery detection mechanism 290 is not limited to a mechanism that detects the outer peripheral length of the roll 13 based on a signal output from a rotary encoder. For example, each outer periphery detection mechanism 290 may detect the outer peripheral length of the roll 13 by reading reflected light from the outer periphery of the roll 13 using an optical sensor or the like. The outer peripheral length of the roll 13 detected by the outer periphery detection mechanism 290 is supplied to the control unit 501.

The control unit 501 is connected to each part of the sheet conveyance unit 30. The parts of the sheet conveyance unit 30 include the conveyance motor 303. As illustrated in FIG. 2, the conveyance motor 303 is a motor that rotates the conveyance roller 302 in the normal rotation direction A1 or the reverse rotation direction A2. If the conveyance roller 302 rotates in the normal rotation direction A1, the sheet 12 is pulled out from the roll 13 and advances in the conveyance direction. That is, the normal rotation direction A1 corresponds to the conveyance direction of the sheet 12. The conveyance motor 303 drives the conveyance roller 302 under the control of the control unit 501, and rotates the conveyance roller 302 in the normal rotation direction A1 or the reverse rotation direction A2.

The control unit 501 is connected to each part of the printing unit 40. The parts of the printing unit 40 include the print head 401. The print head 401 ejects ink from ejection ports under the control of the control unit 501.

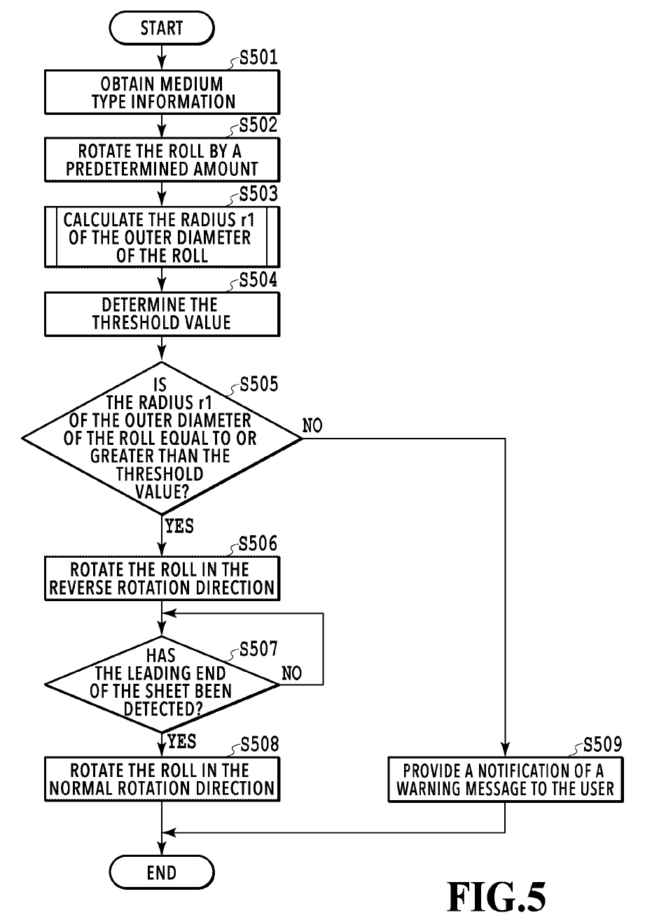

FIG. 5 is a flowchart illustrating an example of the automatic sheet supply processing in the first embodiment. The series of processes (the automatic sheet supply processing) illustrated in the flowchart of FIG. 5 is implemented by the CPU 502 reading out a program stored in the ROM 503 or the like into the RAM 504 and executing it. Note that part or all of the functions in the steps of FIG. 5 may be implemented by hardware such as an ASIC or an electronic circuit. The symbol "S" in the description of each process indicates that it is a step in the flowchart diagram (the same applies hereinafter to the flowchart diagrams in this specification).

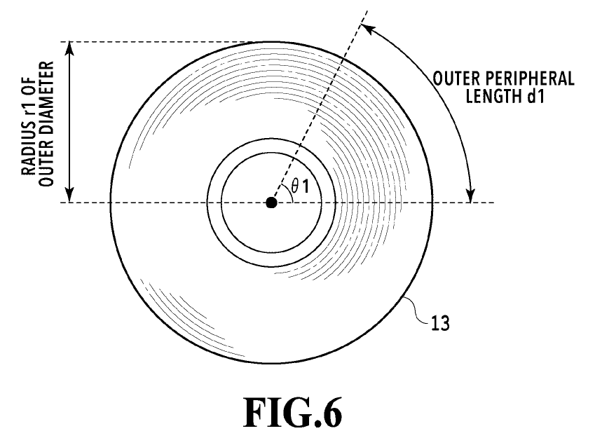

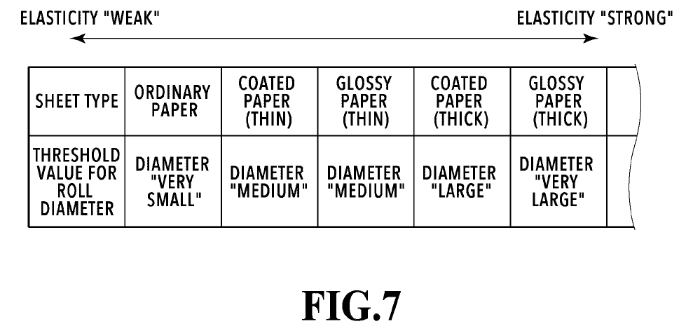

FIG. 6 is a diagram for describing calculation of the radius r1 of an outer diameter of the roll 13. FIG. 7 is a diagram illustrating the threshold value table 700. Hereinafter, a description is given with reference to FIG. 5 through FIG. 7. The series of processes (sheet supply processing) in the flowchart illustrated in FIG. 5 is started upon receiving a command for printing an image from the operation panel 14 or the like.

In S501, the CPU 502 obtains medium type information. This medium type information is information indicating the type of the roll 13 held by the roll holding unit 11. The type of the roll 13 held by the roll holding unit 11 is designated by the user using the operation panel 14 or the like. If the user designates the type of the roll 13 held by the roll holding unit 11 using the operation panel 14 or the like, medium type information indicating the designated type of the roll 13 is stored in the RAM 504. After obtaining the medium type information, the CPU 502 proceeds the processing to S502.

In S502, in order to calculate the radius r1 of the outer diameter of the roll 13, the CPU 502 controls the supply motor 270 to rotate the roll 13 by a predetermined amount in the normal rotation direction D1 or the reverse rotation direction D2. Thereafter, the CPU 502 proceeds the processing to S503.

In S503, the CPU 502 obtains the radius r1 (FIG. 6) of the outer diameter of the roll 13 by calculation. For example, in S503, the CPU 502 obtains the angle θ1 (FIG. 6) of the roll 13, based on a rotation amount detected by the rotation detection mechanism 280 in a condition that the roll 13 has rotated by the predetermined amount. Further, in S503, the CPU 502 obtains the outer peripheral length d1 (FIG. 6) detected by the outer periphery detection mechanism 290 in a condition that the roll 13 has rotated by the predetermined amount. After obtaining the angle θ1 of the roll 13 and the outer peripheral length d1 of the roll 13, the CPU 502 obtains the radius r1 of the outer diameter of the roll 13 by calculation. For this calculation, for example, the formula r1 = (180×d1)/(π×θ1) is used. Thereafter, the CPU 502 proceeds the processing to S504.

In S504, the CPU 502 uses the threshold value table 700 (FIG. 7) to determine a threshold value to be compared with the radius r1 of the outer diameter of the roll 13 calculated in S503. The threshold value table 700 is a table that defines threshold values for the respective types of print media. The threshold value table 700 is stored in a storage device that may be referenced by the CPU 502. For example, the threshold value table 700 is stored in the ROM 503, the storage unit 505, the host device 520, or the like. In the threshold value table 700, different threshold values are set in association with multiple types of print media, respectively. Specifically, the weaker the elasticity of the type of print medium (the lower the elastic modulus), the smaller the threshold value is set.

In the example of FIG. 7, the types of print media include ordinary paper, coated paper (thin), glossy paper (thin), coated paper (thick), and glossy paper (thick). The threshold value ("very small") for ordinary paper is smaller than the threshold value ("medium") for coated paper (thin) and glossy paper (thin), which have elastic moduli greater than that of ordinary paper. The threshold value ("medium") for glossy paper (thin) is smaller than the threshold value ("large") for coated paper (thick), which has an elasticity modulus greater than that of glossy paper (thin). The threshold value ("large") for coated paper (thick) is smaller than the threshold value ("very large") for glossy paper (thick), which has an elasticity modulus greater than that of coated paper (thick).

The CPU 502 uses the threshold value table 700 to determine a threshold value corresponding to the type of print medium indicated by the medium type information obtained in S501. Thereafter, the CPU 502 proceeds the processing to S505.

In S505, the CPU 502 compares the radius r1 of the outer diameter of the roll 13 calculated in S503 with the threshold value determined in S504. In a case where a comparison result in which the radius r1 of the outer diameter of the roll 13 is equal to or greater than the threshold value is obtained, the comparison result indicates that the degree of curvature of the outer diameter of the roll 13 is not large. In this case, the CPU 502 proceeds the processing to S506.

In S506, the CPU 502 controls the supply motor 270 to rotate the roll 13 in the reverse rotation direction D2. Thereafter, the CPU 502 proceeds the processing to S507.

In S507, the CPU 502 judges whether or not the rotation detection mechanism 280 has detected the leading end of the sheet. If the rotation detection mechanism 280 detects the leading end of the sheet, the CPU 502 proceeds the processing to S508.

In S508, the CPU 502 controls the supply motor 270 to rotate the roll 13 in the normal rotation direction D1, thereby starting the automatic supply of the sheet 12 from the roll 13. If the roll 13 is rotated in the normal rotation direction D1, the leading end of the sheet passes above the first follower rotating body 250 and the second follower rotating body 260 (FIG. 3), and is then pulled out from the roll 13 and automatically inserted between the arm member 220 and the separation flapper 210. At this time, the CPU 502 controls the rotating cam 231 (FIG. 3) to adjust the pressing force applied by the biasing member 232 to the arm member 220. If the automatic supply of the sheet 12 from the roll 13 is started, the series of processes illustrated in the flowchart of FIG. 5 ends.

In S505, in a case where a comparison result in which the radius r1 of the outer diameter of the roll 13 is smaller than the threshold value is obtained, the comparison result indicates that the degree of curvature of the outer diameter of the roll 13 is large. In this case, the CPU 502 proceeds the processing to S509.

In S509, the CPU 502 provides a notification of a warning message to the user. That is, the CPU 502 provides a notification of a warning message to the user in a state where control of the supply motor 270 is stopped, without performing the automatic supply of the sheet 12 from the roll 13. The warning message includes content suggesting a possibility that a feeding malfunction of the sheet 12 may occur. Note that the notification of a warning message may include displaying it in a display area such as a screen or a space. Alternatively, the notification of a warning message may include a notification from a speaker. Alternatively, the notification of a warning message may include turning on or flashing a warning light. Alternatively, the notification of a warning message may include vibration of a vibration unit. Alternatively, the notification of a warning message may be a combination of at least two of the displaying in a display area, notification from a speaker, lighting or flashing of a warning light, and vibration of a vibration unit. Once the notification of a warning message is provided, the series of processes illustrated in the flowchart of FIG. 5 ends.

As described above, according to the present embodiment, it is possible to prevent conveyance malfunctions of the sheet 12 in advance. For example, the CPU 502 provides a notification of a warning message including content suggesting a possibility that a supply malfunction of the sheet 12 may occur, based on the radius r1 of the outer diameter of the roll 13 held by the roll holding unit 11. This allows the user to have an opportunity to check the state of the roll 13, etc., before the sheet 12 pulled out from the roll 13 is conveyed by the sheet conveyance unit 30. As a result, it is possible to prevent conveyance malfunctions of the sheet 12 in advance. Further, since occurrence of stopping of the conveyance operation after a conveyance malfunction of the sheet 12 occurs is prevented, waste of an area of the sheet 12 where a conveyance malfunction occurs is eliminated.

Further, in a case where the radius r1 of the outer diameter of the roll 13 held by the roll holding unit 11 indicates that the degree of curvature is greater than the threshold value, the CPU 502 provides a notification of a warning message. This allows for proper notification of the possibility that a supply malfunction of the sheet 12 may occur.

Further, the threshold value to be compared with the radius r1 of the outer diameter of the roll 13 varies depending on the type of print medium. Alternatively, in a case where the elastic modulus of the print medium is a first elastic modulus, the threshold value is smaller than in a case where the elastic modulus is a second elastic modulus that is greater than the first elastic modulus. This allows for proper notification of the possibility that a supply malfunction of the sheet 12 may occur.

### Second Embodiment

In the first embodiment, a description is given of an example in which automatic supply of the sheet 12 from the roll 13 is not performed in a case where a comparison result between the radius r1 of the outer diameter of the roll 13 and a threshold value indicates that the degree of curvature of the outer diameter of the roll 13 is large. In the present embodiment, a description is given of an example in which the user is allowed to choose whether or not to perform automatic supply of the sheet 12 from the roll 13 in a case where a comparison result between the radius r1 of the outer diameter of the roll 13 and a threshold value indicates that the degree of curvature of the outer diameter of the roll 13 is large.

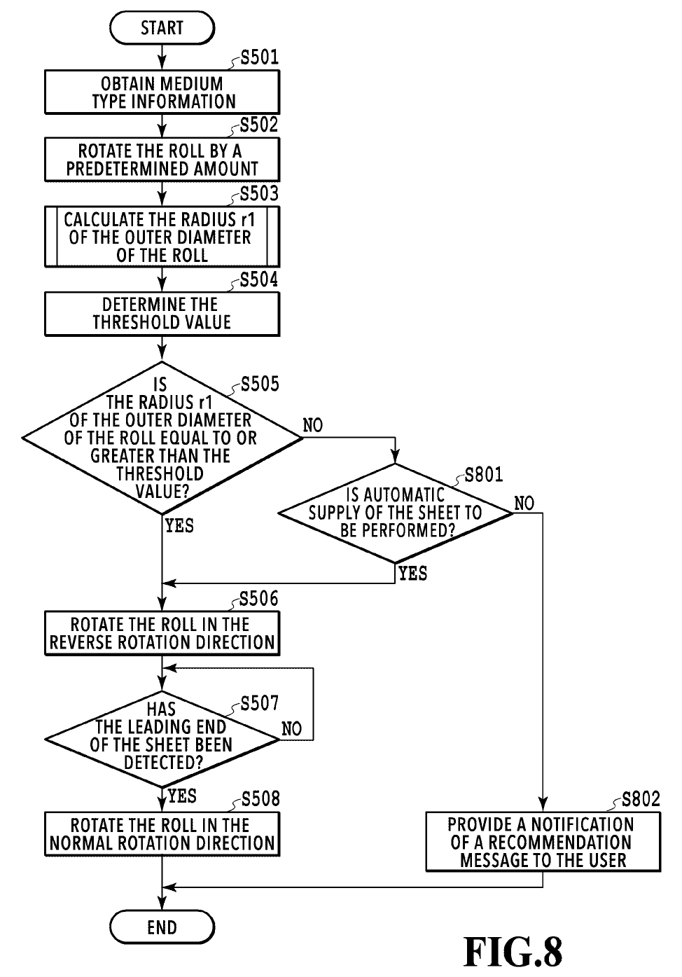

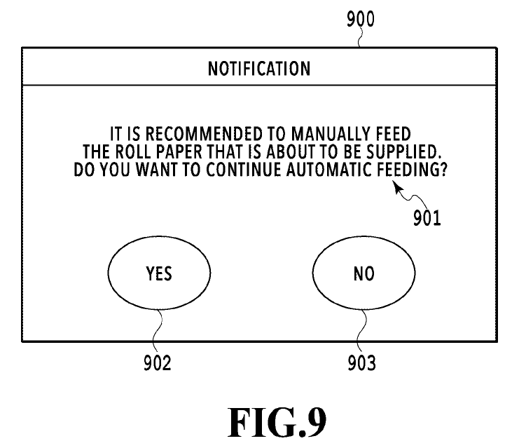

FIG. 8 is a flowchart illustrating an example of the automatic sheet supply processing in the second embodiment. FIG. 9 is a diagram illustrating an example of the notification screen 900. Hereinafter, the description is given with reference to FIG. 8 and FIG. 9, but descriptions of the contents common to the first embodiment are omitted as appropriate.

In the present embodiment, in S505, if the radius r1 of the outer diameter of the roll 13 is smaller than the threshold value, the CPU 502 proceeds the processing to S801. In S801, the CPU 502 notifies the user of a selection message. The selection message includes content for selecting whether or not to perform automatic supply of the sheet 12. For example, the CPU 502 displays the notification screen 900 on a display unit of the printing apparatus 10. This display unit may be the operation panel 14.

The notification screen 900 includes the selection message 901, the first button 902, and the second button 903. As the selection message 901, a message prompting selection as to whether or not to perform automatic supply of the sheet 12 is displayed. The first button 902 is a button for receiving an instruction to perform automatic supply of the sheet 12. The second button 903 is a button for receiving an instruction not to perform automatic supply of the sheet 12. The user can select whether or not to perform automatic supply of the sheet 12 by pressing the first button 902 or the second button 903.

In the example of FIG. 9, the notification of the selection message 901 is displayed on a screen; however, there is no such limitation. The notification of the selection message 901 may be displayed in a space. Alternatively, the notification of the selection message 901 may be a notification from a speaker. Alternatively, the notification of the selection message 901 may be a combination of at least two of the displaying on a screen, displaying in a space, and notification from a speaker. Further, in the example of FIG. 9, both the first button 902 and the second button 903 are GUI buttons (soft keys); however, at least one of them may be a physical button (a hard key).

If an instruction to perform automatic supply of the sheet 12 is received, the CPU 502 proceeds the processing to S506. On the other hand, if an instruction not to perform automatic supply of the sheet 12 is received, the CPU 502 proceeds the processing to S802.

In S802, the CPU 502 notifies the user of a recommendation message indicating that manual supply is recommended. That is, the CPU 502 notifies the user of a recommendation message in a state where control of the supply motor 270 is stopped, without performing the automatic supply of the sheet 12 from the roll 13. The format of the notification of a recommendation message is the same as that of the notification of a warning message described in S509 of the first embodiment. Note that, in the example of FIG. 9, the recommendation message is included in the selection message 901 displayed in S801. In this case, the process of S802 need not be performed.

As explained above, according to the present embodiment, if the radius r1 of the outer diameter of the roll 13 indicates that the degree of curvature is greater than a threshold value, a notification of a selection message including content for selection as to whether or not to perform automatic supply of the sheet is provided. This makes it possible to check whether or not a jam will occur or the like, and as a result, it is possible to appropriately determine the subsequent supply operation of the sheet 12.

### Other Embodiments

In the above-described embodiments, the timing at which automatic supply of the sheet 12 starts is after the radius r1 of the outer diameter of the roll 13 is compared with a threshold value; however, there is no such limitation. For example, the timing at which the automatic supply of the sheet 12 starts may be before the radius r1 of the outer diameter of the roll 13 is compared with the threshold value. Specifically, after the process of S501, the CPU 502 sequentially executes the processes of S506 to S508. Further, after the process of S508, the CPU 502 sequentially executes the processes of S502 to S505. If the radius r1 of the outer diameter of the roll 13 is equal to or greater than the threshold value in S505, the CPU 502 ends the series of processes. On the other hand, if the radius r1 of the outer diameter of the roll 13 is smaller than the threshold value in S505, the CPU 502 stops control of the supply motor 270 to stop the rotation of the roll 13, and then executes the process of S509. Then, the CPU 502 ends the series of processes.

In the above-described embodiments, the processes of S501 to S505 and the process of S509 are related to the processing for automatic supply of the sheet 12; however, they may not be related. For example, the printing apparatus 10 includes a reception unit for receiving an instruction to execute a judgement process. The judgement process is a process for judging whether the sheet 12 pulled out from the roll 13 will be supplied properly. The reception unit may be a GUI button or a physical button. If an execution instruction is received from the reception unit, the judgement process starts. In this case, the CPU 502 sequentially executes the processes of S501 to S505. In S505, if the radius r1 of the outer diameter of the roll 13 is equal to or greater than the threshold value, the judgement process ends. On the other hand, in S505, if the radius r1 of the outer diameter of the roll 13 is smaller than the threshold value, the CPU 502 executes the process of S509. Then, the judgement process ends.

In the above-described embodiments, the value indicating the degree of curvature of the outer periphery of the roll 13 is the radius r1 of the outer diameter of the roll 13; however, there is no such limitation. For example, the value indicating the degree of curvature of the outer periphery of the roll 13 may be the outer diameter of the roll 13. Alternatively, the value indicating the degree of curvature of the outer periphery of the roll 13 may be the radius of curvature of the outer periphery of the roll 13. Alternatively, the value indicating the degree of curvature of the outer periphery of the roll 13 may be the curvature of the outer periphery of the roll 13. The curvature is the reciprocal of the radius of curvature. Therefore, a comparison result indicating that the degree of curvature of the outer periphery of the roll 13 is large is opposite to that of the above-described embodiments. That is, if a comparison result in which the curvature is smaller than the threshold value is obtained, the comparison result indicates that the degree of curvature of the outer periphery of the roll 13 is not large. On the other hand, if a comparison result in which the curvature is equal to or greater than the threshold value is obtained, the comparison result indicates that the degree of curvature of the outer periphery of the roll 13 is large.

In the above-described embodiments, the CPU 502 obtains the value indicating the degree of curvature of the outer periphery of the roll 13 by calculation; however, there is no such limitation. For example, the CPU 502 may obtain a value input by the user using the operation panel 14 or the like as the value indicating the degree of curvature of the outer periphery of the roll 13. Alternatively, the CPU 502 may obtain the value indicating the degree of curvature of the outer periphery of the roll 13 from a table. For example, in the table, a value indicating the degree of curvature of the outer periphery of the roll 13 is associated with each type of print medium. In this case, the CPU 502 obtains a value associated with the type of print medium indicated by the medium type information as the value indicating the degree of curvature of the outer periphery of the roll 13.

In the above-described embodiments, the CPU 502 of the printing apparatus 10 executes the series of processes illustrated in the flowchart of FIG. 5 or FIG. 8; however, there is no such limitation. For example, the CPU of the host device 520 may execute the series of processes illustrated in the flowchart of FIG. 5 or FIG. 8. Alternatively, the CPU 502 of the printing apparatus 10 may execute part of the series of processes illustrated in the flowchart of FIG. 5 or FIG. 8, and another device such as the host device 520 may execute the other processes.

At least part of the above-described various processes to be performed by the CPU 502 may be executed by one or multiple pieces of hardware. For example, at least part of the processing performed by the CPU 502 to function as a notification unit that provides a notification related to supply of the roll 13 based on the degree of curvature of the outer periphery of the roll 13 held by the roll holding unit 11 may be implemented by hardware. Alternatively, at least part of the processing performed by the CPU 502 to function as an obtaining unit that obtains a value indicating the degree of curvature of the outer periphery of the roll 13 may be implemented by hardware. Alternatively, at least part of the processing performed by the CPU 502 to function as a motor control unit that controls the supply motor 270 may be implemented by hardware. Note that the supply motor 270 is a motor that rotates the roll 13 held by the roll holding unit 11.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, conveyance malfunctions of a sheet may be prevented in advance.

This application claims the benefit of Japanese Patent Application No. 2025-010515, filed January 24, 2025, which is hereby incorporated by reference herein in its entirety.

What is claimed is:

1. A sheet supply apparatus comprising:
a roll holding unit configured to rotatably hold a roll on which a sheet that serves as a print medium is wound;
one or more memories storing instructions; and
one or more processors which function as:
a notification unit configured to provide a notification related to supply of the roll, based on a degree of curvature of an outer periphery of the roll held by the roll holding unit.

2. The sheet supply apparatus according to claim 1,
wherein the notification unit provides a notification of a warning message including content suggesting a possibility that a supply malfunction of the sheet may occur.

3. The sheet supply apparatus according to claim 1,
wherein the notification unit provides a notification of a selection message including content for selection as to whether or not to perform automatic supply of the sheet.

4. The sheet supply apparatus according to claim 1,
wherein the one or more processors further function as:
an obtaining unit configured to obtain a value indicating the degree of curvature, and
wherein, in a case where a comparison result between the value and a threshold value indicates that the degree of curvature is large, the notification unit provides a notification related to the roll.

5. The sheet supply apparatus according to claim 4, further comprising:
a motor configured to rotate the roll held by the roll holding unit,
wherein the one or more processors further function as:
a motor control unit configured to control the motor, and
wherein, in a case where the comparison result between the value and the threshold value indicates that the degree of curvature is not large, the motor control unit rotates the motor.

6. The sheet supply apparatus according to claim 4, further comprising:
a first detection mechanism configured to detect a rotation amount of the roll; and
a second detection mechanism configured to detect an outer peripheral length, which is a length of an outer periphery of the roll,
wherein, based on the rotation amount and the outer peripheral length detected in a condition that the roll is rotated by a predetermined amount, the obtaining unit obtains, as the value, an outer diameter of the roll or a radius of the outer diameter of the roll.

7. The sheet supply apparatus according to claim 4,
wherein the threshold value varies depending on a type of the print medium.

8. The sheet supply apparatus according to claim 4,
wherein, in a case where an elastic modulus of the print medium is a first elastic modulus, the threshold value is smaller than in a case where the elastic modulus is a second elastic modulus that is greater than the first elastic modulus.

9. A control apparatus comprising:
one or more memories storing instructions; and
one or more processors which function as:
obtaining a value indicating a degree of curvature of an outer periphery of a roll on which a sheet that serves as a print medium is wound; and
stopping control of a motor in a case where a comparison result between the value and a threshold value indicates that the degree of curvature is large.

10. A printing apparatus comprising:
a roll holding unit configured to rotatably hold a roll on which a sheet that serves as a print medium is wound;
a sheet conveyance unit configured to convey the sheet pulled out from the roll held by the roll holding unit;
a printing unit configured to print an image on the sheet conveyed by the sheet conveyance unit;
one or more memories storing instructions; and
one or more processors which function as:
providing a notification related to supply of the roll, based on a degree of curvature of an outer periphery of the roll held by the roll holding unit.
